(19) United States
(12) Patent Application Publication
(10) Pub. No.: US 2025/0355759 A1
(43) Pub. Date: Nov. 20, 2025

(54) INJECTOR FAILURE MODE IDENTIFICATION

(71) Applicant: Cummins Inc., Columbus, IN (US)

(72) Inventor: Shiyuan Zhao, Hanyang District (CN)

(21) Appl. No.: 19/207,552

(22) Filed: May 14, 2025

(30) Foreign Application Priority Data
May 17, 2024 (CN) 202410619825.5

(51) Int. Cl. G06F 11/07; F02D 41/22; F02D 41/30

(52) U.S. Cl. CPC G06F 11/0793; F02D 41/22; F02D 41/3005; G06F 11/0739; F02D 2041/224

(57) ABSTRACT

A process for identifying fueling system failure modes includes operating a failure mode model derived from a big data dataset, the big data dataset comprising field performance data received from a plurality of engine fueling systems including one or more injectors, the field performance data comprising injection pressures and injection quantitates for a plurality of injections performed by one or more injectors of the engine fueling systems, the failure mode model including a plurality of predetermined rules for evaluating operation of engine fueling systems; receiving target field performance data from a target fueling system including one or more target injectors configured to provide fuel to a target engine system for performance evaluation; evaluating the target field target performance data using the failure mode model to identify a failure mode of the target fueling system; and performing a compensatory action in response to the evaluating.

### TECHNICAL FIELD

The present application relates to injector failure mode identification and more particularly but not exclusively to big data-based artificial intelligence models for injector failure mode identification.

### BACKGROUND

Fuel injectors for internal combustion engine systems may experience a number of failures which may involve any of a number of fuel injector components. A number of efforts have been made to provide diagnostics for fuel injector failures. Such efforts suffer from a number of disadvantages and shortcomings including those respecting accuracy, precision, reliability, feasibility and speed of data processing, among others. There remains a significant need for the unique apparatuses, processes, and systems disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY

Example embodiments include unique apparatuses, processes,+ and systems for injector failure mode identification. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example system for injector failure mode identification.

FIG. 2 is a flow diagram illustrating certain aspects of an example process for injector failure mode identification.

FIG. 3 is a schematic diagram illustrating certain aspects of an example process for injector failure mode identification.

FIG. 4 is a schematic diagram illustrating certain aspects of an example process for injector failure mode identification.

### DETAILED DESCRIPTION OF EXAMPLE EMBODIMENTS

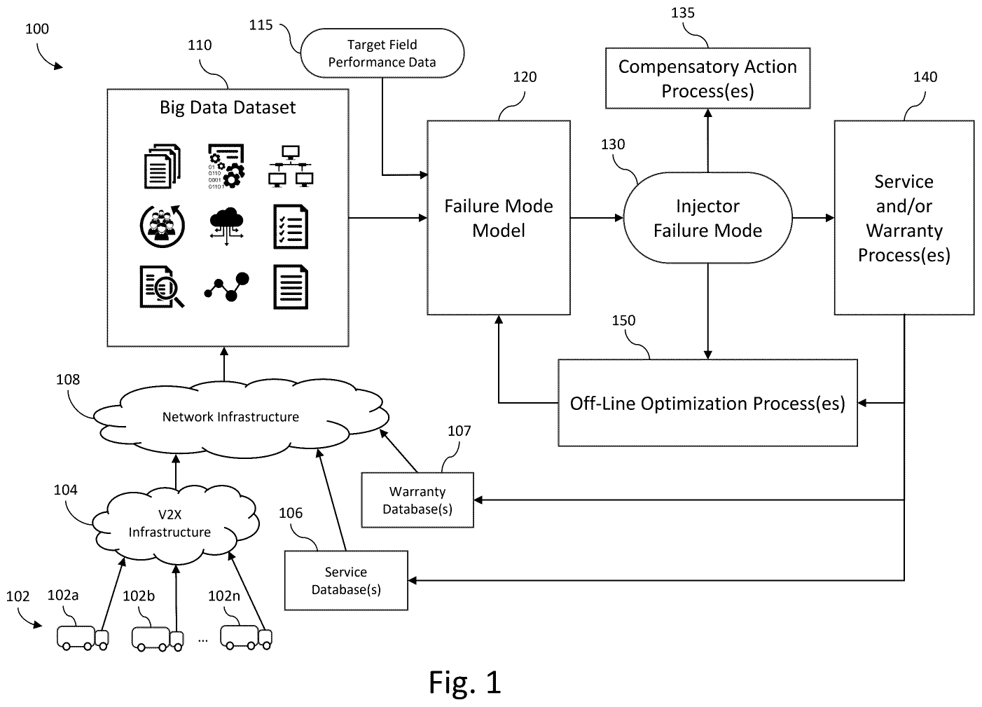

With reference to FIG. 1, there is illustrated an example system 100 which is configured and operable to evaluate and determine one or more failure modes of one or more fuel injectors. System 100 includes dataset 110. In the illustrated example, dataset 110 comprises a big data dataset. As understood by one of skill in the art, big data refers to data sets that are so large, fast or complex as to be difficult or impossible to process using traditional data processing techniques. Dataset 110 may receive and store field performance data of a plurality of vehicles 102. In the illustrated example, the plurality vehicles 102 include an arbitrarily large plurality of vehicles 102a, 102b, 102n, whose number may vary and increase over time. Vehicles 102 may continually or repeatedly output and provided field performance data, including fuel system field performance data, to dataset 110 via vehicle-to-X (V2X) infrastructure 104 and network infrastructure 108. Dataset 110 may also receive service data relating to the plurality of vehicles 102 from one or more service databases 106 via network infrastructure 108. Dataset 110 may also receive warranty data relating to the plurality of vehicles 102 from one or more warranty databases 107 via network infrastructure 108.

System 100 further includes a failure mode model 120 which is constructed using a dataset 110. Failure mode model 120 comprises a plurality of rules for evaluating operation of engine fueling systems. The rules may be constructed using field performance data received a plurality of engine fueling systems including one or more injectors. The field performance data may comprise injection pressures and injection quantitates for a plurality of injections performed by one or more injectors of the engine fueling systems.

Failure mode model 120 is configured and operable to receive target field performance data 115 from a target fueling system or a target engine identified or selected for evaluation by failure mode model 120, for example, by an identification or selection initiated by a vehicle or other asset with which the target engine is associated or initiated my failure mode model 120 or an associated component of system 100. The target fueling system comprise one or more target injectors configured to provide fuel to a target engine system for performance evaluation. Failure mode model 120 is further configured and operable to determine and provide an injector failure mode output 130 which may comprise, for example, a diagnostic output, a prognostic output, or a combination thereof.

Injector failure mode output 130 may be provided to and utilized by one or more compensatory action processes 135 which may comprise, for example, one or more of: modifying operation of the target engine system, providing an operator perceptible notification to an operator of the target engine system, and scheduling service of the target engine system.

Injector failure mode output 130 may also be provided to and utilized by one or more service and/or warranty processes 140 at which the target fuel injection system may be serviced and service information may be entered into one or more databases such as service databas(es) 106, and/or a warranty claim may be processed and warranty information may be entered into one or more databases such as service databas(es) 107. Information of service and/or warranty processes 140 may also be utilized by off-line optimization process(es) 150 to update failure mode model 120.

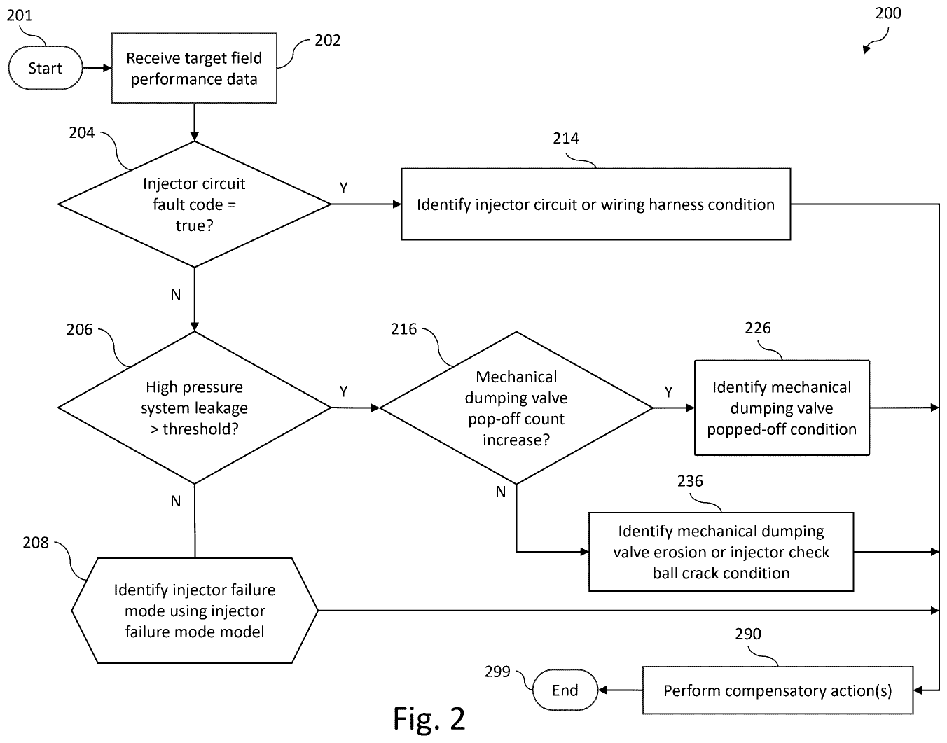

With reference to FIG. 2, there is illustrated an example process 200 which may be utilized in connection with failure mode identification of one or more injectors of one or more target fueling systems. Process 200 begins start operation 201 and proceeds to operation 202 at which target field performance data is received. The received target field performance data may comprise the injection pressures and injection quantitates for a plurality of injections performed by one or more injectors of the engine fueling systems.

From operation 202, process 200 proceeds to conditional 204 which evaluates whether an injector circuit fault code is true. The injector fault code may be a component of or may be determined in response to the received target field performance data.

If conditional 204 evaluates affirmative, process 200 proceeds to operation 214 which identifies an injector circuit or injector wiring harness condition. From operation 214, process 200 proceeds to operation 290 which is further described below.

If conditional 204 evaluates negative, process, 200 proceeds to conditional 206 which evaluates whether a high pressure system leakage value is greater than a threshold. The high pressure system leakage value may be a component of or may be determined in response to the received target field performance data.

If conditional 206 evaluates affirmative, process 200 proceeds to conditional 216 which evaluates whether a mechanical dumping valve pop-off count has increased. The mechanical dumping valve pop-off count may be a component of or may be determined in response to the received target field performance data.

If conditional 216 evaluates affirmative, process 200 proceeds to operation 226 which identifies a mechanical dumping valve pop-off condition. From operation 226, process 200 proceeds to operation 290 which is further described below.

If conditional 216 evaluates negative, process 200 proceeds to operation 236 which identifies a mechanical dumping valve erosion condition or an injector check ball crack condition. From operation 226, process 200 proceeds to operation 290 which is further described below.

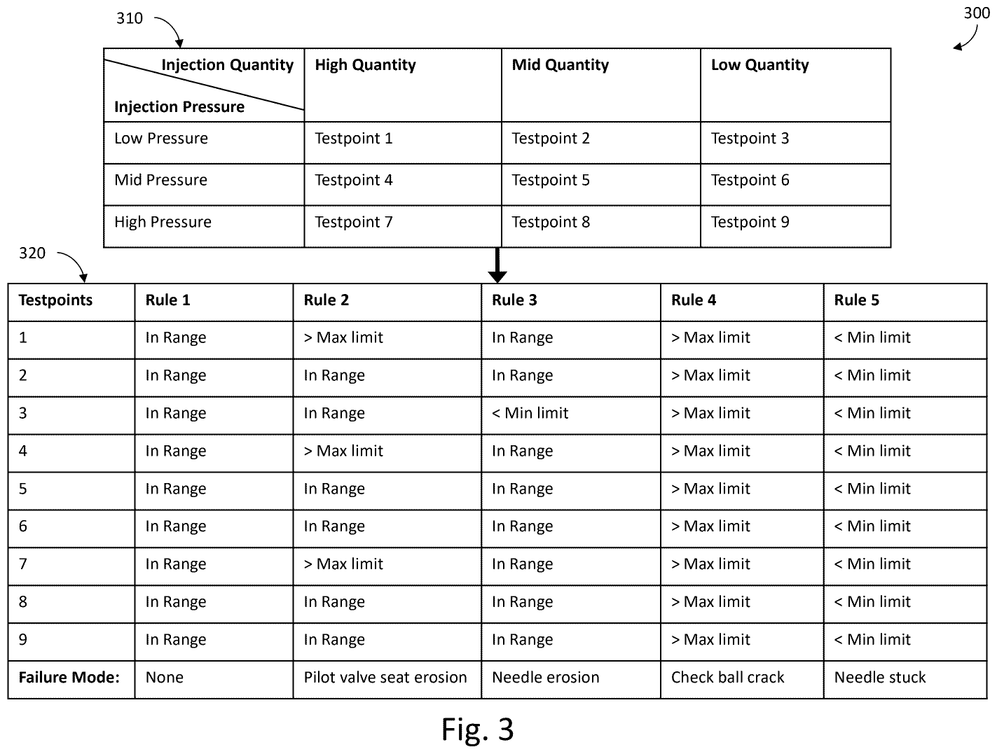

If conditional 206 evaluates negative, process 200 proceeds to operation 208 which identifies an injector failure mode using injector failure mode and the received target field performance data. Operation 208 may, for example, utilize operations and techniques such as those of process 300 illustrated and described in connection with FIG. 3. From operation 208, process 200 proceeds to operation 290.

Operation 290 performs one or more compensatory actions. The one or more compensatory actions may comprise, for example, one or more of: modifying operation of the target engine system, providing an operator perceptible notification to an operator of the target engine system, and scheduling service of the target engine system. Modifying operation of the target engine system may comprise derating the target engine, for example, by imposing lower engine torque limits, lower engine speed limits, and/or lower engine power limits, deactivating one or more injectors of the target engine, or other modifications as will occur to one of skill in the art with the benefit and insight of the present disclosure. From operation 290, process 200 proceeds to end operation 299 and may thereafter repeat or be re-called or re-initiated.

With reference to FIG. 3, there is illustrated an example process 300 which may be utilized in connection with failure mode identification of one or more injectors of one or more target fueling systems. Process 300 includes test point construction operation 310 which is configured and operable to define a plurality of test points applicable to fuel injector field performance data comprising information of a plurality of injection events including respective injection quantities and injection pressures. In the illustrated example, operation 310 is configured to classify or sort fuel injector field performance data into injection quantity categories and injection pressure quantities.

In the illustrated example the injection quantity categories comprises three categories, namely high injection quantity, medium injection quantity and low injection quantity. The injection quantity categories may be defined by ranges of injection quantities or by discrete injection quantities. The ranges of injection quantities may be selected and utilized to mitigate or reduce a data processing burden by excluding data outside the ranges of injection quantities, with the use of discrete injection quantities being the most exclusionary possibility. The ranges of injection quantities may be selected and utilized based upon empirical or statistical techniques to enhance or maintain failure mode signal strength while also reducing data volume. It shall be appreciated that a different number of injection quantities, category definitions, and/or category ranges may be defined and utilized in other embodiments.

In the illustrated example the injection pressure categories comprises three categories, namely high injection pressure, medium injection pressure and low injection pressure. The ranges of injection pressures may be selected and utilized to mitigate or reduce a data processing burden by excluding data outside the ranges of injection pressures, with the use of discrete injection pressures being the most exclusionary possibility. The ranges of injection pressures may be selected and utilized based upon empirical or statistical techniques to enhance or maintain failure mode signal strength while also reducing data volume. It shall be appreciated that a different number of injection pressures, category definitions, and/or category ranges may be defined and utilized in other embodiments.

Process 300 includes rule construction operation 320 which is configured and operable receive output of test point construction operator 310 and in response thereto to define a plurality of failure mode identification rules for fuel injector field performance data comprising information of a plurality of injection events including respective injection quantities and injection pressures. In the illustrated example, operation 310 is configured to classify or sort fuel injector field performance data into injection quantity categories and injection pressure quantities.

In the illustrated example, rule construction operator has constructed a set of five rules configured and operable to judge target field performance data relative to the test points established by test point construction operator 310. Each of the five rules comprises a unique set of range evaluations for each the test points established by test point construction operator 310. In the illustrated example the range of evaluations comprises three evaluations, namely under a minimum limit, in range, and over a maximum limit. It shall be appreciated that other range evaluations may also be utilized as will occur to one of skill in the art with the benefit and insight of the present disclosure. Furthermore, each set of the range evaluation corresponds to a particular failure mode. Thus, once the rule of rule construction operation 320 are established, the rules may be implemented in failure mode model such as failure mode model 120 and utilized to identify injector failure mode in response to target field performance data.

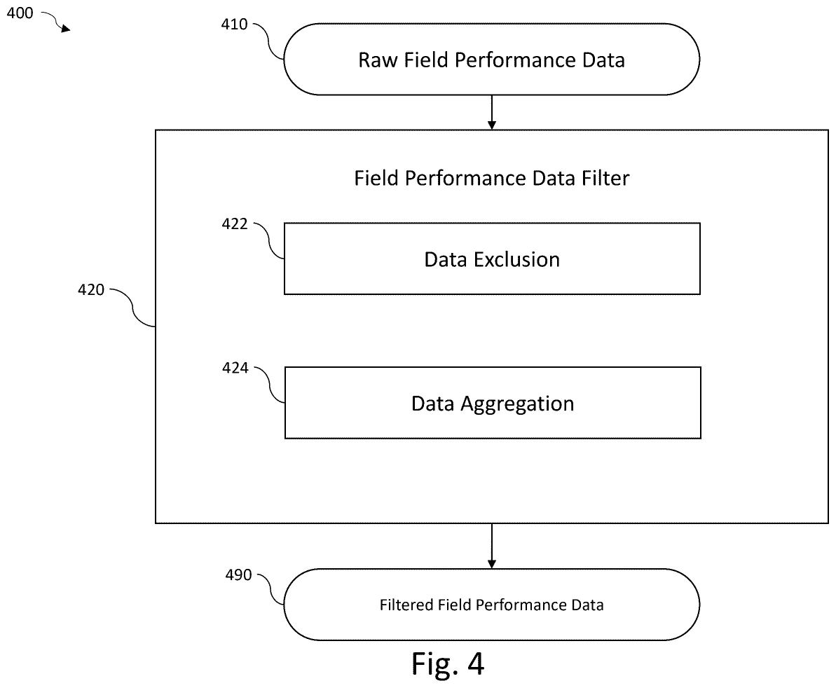

With reference to FIG. 4, there is illustrated an example process 400 which may be utilized in processing data of a big data dataset, such dataset 110, for example, as a filter on inputs received by such a dataset or as a data curation tool applied to such a dataset after inputs are received thereby. In process 400, raw filed performance data 410 may be provided to field performance data filter 420. In turn, field performance data filter 420 is configured to determine and provide as output filtered field performance data 490.

Field performance data filter 420 includes a data exclusion operator 422 and a data aggregation operator 424. In the illustrated example, data exclusion operator 422 is configured to determine cleaned data for each injector and each fueling point (Cdk) in accordance with equation (1):

$${Cd}^{k} = {fp}_{i}^{k} ( ∼ nan ( {fp}_{i}^{k} ) \& ∼ ( {fp}_{i}^{k} ) = 0 ) \qquad ( 1 )$$

In equation (1) i denotes an injector number, j denotes an individual day for which field performance data is available, k denotes an index, f p^{k}denotes a fueling point at index k, ˜ denotes an exclusionary filter,

$$nan ( {fp}_{i}^{k} )$$

denotes a fueling point at index k that is not a number, and

$$( {fp}_{i}^{k} ) = 0$$

denotes a fueling point at index k that has a zero value. Thus, equation (1) is effective to filter out data points that not ultimately useful, for example, because they have been corrupted, include an error indication or flag, are absent, or are otherwise unsuitable according to the rules of equation (1).

In the illustrated example, data exclusion operator 422 of field performance data filter 420 is configured to determine aggregated daily cleaned data for each injector and each fueling point

$$( {y}_{j}^{k} )$$

in accordance with equation (2):

$${y}_{j}^{k} = {mean ( {Cd}^{k} )}_{j} \qquad ( 2 )$$

In equation (2), j denotes an individual day for which field performance data is available, k denotes an index, avg denotes an average such as an arithmetic mean or a weighted average, and C d^{k} denotes cleaned data for each injector and each fueling point. Thus, equation (2) is effective compress the data volume

As shown by this detailed description, the present disclosure contemplates multiple and various embodiments, including, without limitation, the following example embodiments.

Example embodiment number 1 is process for identifying fueling system failure modes, the process comprising: operating a failure mode model derived from a big data dataset, the big data dataset comprising field performance data received from a plurality of engine fueling systems including one or more injectors, the field performance data comprising injection pressures and injection quantitates for a plurality of injections performed by one or more injectors of the engine fueling systems, the failure mode model including a plurality of predetermined rules for evaluating operation of engine fueling systems; receiving target field performance data from a target fueling system including one or more target injectors configured to provide fuel to a target engine system for performance evaluation; evaluating the target field target performance data using the failure mode model to identify a failure mode of the target fueling system; and performing a compensatory action in response to the evaluating.

Example embodiment number 2 includes the features of example embodiment number 1, wherein the evaluating comprises evaluating the target field target performance data relative to the plurality of predetermined rules.

Example embodiment number 3 includes the features of example embodiment number 2, wherein each of the plurality of predetermined rules comprises a plurality of test points, each of the plurality of test points comprises a combination of an injection pressure criterion and an injection quantity criterion that is distinct from the others of the plurality of test point, and each of the plurality of predetermined rules specifies whether each test point must be above an upper limit, below a lower limit, or within the and a lower limit.

Example embodiment number 4 includes the features of example embodiment number 2, comprising determining the failure mode of the target fueling system in response to the target field target performance being judged to satisfy one of the plurality of predetermined rules.

Example embodiment number 5 includes the features of example embodiment number 1, comprising performing one or more preliminary fault checks separately from evaluating the target field target performance data using the failure mode model.

Example embodiment number 6 includes the features of example embodiment number 5, wherein the one or more preliminary fault checks comprises evaluating whether an injector circuit fault code condition is true and identifying an injector circuit condition in response to said evaluating.

Example embodiment number 7 includes the features of example embodiment number 5, wherein the one or more preliminary fault checks comprises evaluating whether a pressure exceeds a leakage threshold and whether a mechanical dumping valve pop-off count exceeds a threshold and identifying one of a mechanical dumping valve popped off condition, a mechanical dumping valve erosion condition, and an injector check ball crack condition in response to said evaluating.

Example embodiment number 8 includes the features of example embodiment number 1, wherein the evaluating the field target performance data using the failure mode model comprises diagnosing a present state of the target engine system.

Example embodiment number 9 includes the features of example embodiment number 1, wherein the evaluating the field target performance data using the failure mode model comprises predicting a future state of the target engine system.

Example embodiment number 10 includes the features of example embodiment number 1, wherein the compensatory action comprises one or more of: modifying operation of the target engine system, providing an operator perceptible notification to an operator of the target engine system, and scheduling service of the target engine system.

Example embodiment number 11 is a system for identifying failure modes of a fuel injector, the system comprising: a computer system including one or more processors and one or more non-transitory memory devices configured with instructions executable by the one or more processors to: operate a failure mode model from a big data dataset, the big data dataset comprising field performance data received from a plurality of engine fueling systems including one or more injectors, the field performance data comprising injection pressures and injection quantitates for a plurality of injections performed by one or more injectors of the engine fueling systems, the failure mode model including a plurality of rules for evaluating operation of engine fueling systems; receive target field performance data from a target fueling system including one or more target injectors configured to provide fuel to a target engine system for performance evaluation; evaluate the target field target performance data using the failure mode model to identify a failure mode of the target fueling system; and perform a compensatory action in response to the evaluating.

Example embodiment number 12 includes the features of example embodiment number 11, wherein the instructions are executable by the one or more processors to evaluate the target field target performance data relative to the plurality of predetermined rules.

Example embodiment number 13 includes the features of example embodiment number 12, wherein each of the plurality of predetermined rules comprises a plurality of test points, each of the plurality of test points comprises a combination of an injection pressure criterion and an injection quantity criterion that is distinct from the others of the plurality of test point, and each of the plurality of predetermined rules specifies whether each test point must be above an upper limit, below a lower limit, or within the and a lower limit.

Example embodiment number 14 includes the features of example embodiment number 12, wherein the instructions are executable by the one or more processors to determine the failure mode of the target fueling system in response to the target field target performance being judged to satisfy one of the plurality of predetermined rules.

Example embodiment number 15 includes the features of example embodiment number 11, wherein the instructions are executable by the one or more processors to perform one or more preliminary fault checks separately from evaluating the target field target performance data using the failure mode model.

Example embodiment number 16 includes the features of example embodiment number 15, wherein the one or more preliminary fault checks comprises evaluating whether an injector circuit fault code condition is true and identifying an injector circuit condition in response to said evaluating.

Example embodiment number 17 includes the features of example embodiment number 15, wherein the one or more preliminary fault checks comprises evaluating whether a pressure exceeds a leakage threshold and whether a mechanical dumping valve pop-off count exceeds a threshold and identifying one of a mechanical dumping valve popped off condition, a mechanical dumping valve erosion condition, and an injector check ball crack condition in response to said evaluating.

Example embodiment number 18 includes the features of example embodiment number 11, wherein the instructions are executable by the one or more processors to evaluate the field target performance data using the failure mode model diagnosing a present state of the target engine system.

Example embodiment number 19 includes the features of example embodiment number 11, wherein the instructions are executable by the one or more processors to evaluate the field target performance data using the failure mode model to predict a future state of the target engine system.

Example embodiment number 20 includes the features of example embodiment number 11, wherein the compensatory action comprises one or more of: modifying operation of the target engine system, providing an operator perceptible notification to an operator of the target engine system, and scheduling service of the target engine system.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A process for identifying fueling system failure modes, the process comprising:
operating a failure mode model derived from a big data dataset, the big data dataset comprising field performance data received from a plurality of engine fueling systems including one or more injectors, the field performance data comprising injection pressures and injection quantitates for a plurality of injections performed by one or more injectors of the engine fueling systems, the failure mode model including a plurality of predetermined rules for evaluating operation of engine fueling systems;
receiving target field performance data from a target fueling system including one or more target injectors configured to provide fuel to a target engine system for performance evaluation;
evaluating the target field target performance data using the failure mode model to identify a failure mode of the target fueling system; and
performing a compensatory action in response to the evaluating.

2. The process of claim 1, wherein the evaluating comprises evaluating the target field target performance data relative to the plurality of predetermined rules.

3. The process of claim 2, wherein each of the plurality of predetermined rules comprises a plurality of test points, each of the plurality of test points comprises a combination of an injection pressure criterion and an injection quantity criterion that is distinct from the others of the plurality of test point, and each of the plurality of predetermined rules specifies whether each test point must be above an upper limit, below a lower limit, or within the and a lower limit.

4. The process of claim 2, comprising determining the failure mode of the target fueling system in response to the target field target performance being judged to satisfy one of the plurality of predetermined rules.

5. The process of claim 1, comprising performing one or more preliminary fault checks separately from evaluating the target field target performance data using the failure mode model.

6. The process of claim 5, wherein the one or more preliminary fault checks comprises evaluating whether an injector circuit fault code condition is true and identifying an injector circuit condition in response to said evaluating.

7. The process of claim 5, wherein the one or more preliminary fault checks comprises evaluating whether a pressure exceeds a leakage threshold and whether a mechanical dumping valve pop-off count exceeds a threshold and identifying one of a mechanical dumping valve popped off condition, a mechanical dumping valve erosion condition, and an injector check ball crack condition in response to said evaluating.

8. The process of claim 1, wherein the evaluating the field target performance data using the failure mode model comprises diagnosing a present state of the target engine system.

9. The process of claim 1, wherein the evaluating the field target performance data using the failure mode model comprises predicting a future state of the target engine system.

10. The process of claim 1, wherein the compensatory action comprises one or more of: modifying operation of the target engine system, providing an operator perceptible notification to an operator of the target engine system, and scheduling service of the target engine system.

11. A system for identifying failure modes of a fuel injector, the system comprising:
a computer system including one or more processors and one or more non-transitory memory devices configured with instructions executable by the one or more processors to:
operate a failure mode model from a big data dataset, the big data dataset comprising field performance data received from a plurality of engine fueling systems including one or more injectors, the field performance data comprising injection pressures and injection quantitates for a plurality of injections performed by one or more injectors of the engine fueling systems, the failure mode model including a plurality of rules for evaluating operation of engine fueling systems;
receive target field performance data from a target fueling system including one or more target injectors configured to provide fuel to a target engine system for performance evaluation;
evaluate the target field target performance data using the failure mode model to identify a failure mode of the target fueling system; and
perform a compensatory action in response to the evaluating.

12. The system of claim 11, wherein the instructions are executable by the one or more processors to evaluate the target field target performance data relative to the plurality of predetermined rules.

13. The system of claim 12, wherein each of the plurality of predetermined rules comprises a plurality of test points, each of the plurality of test points comprises a combination of an injection pressure criterion and an injection quantity criterion that is distinct from the others of the plurality of test point, and each of the plurality of predetermined rules specifies whether each test point must be above an upper limit, below a lower limit, or within the and a lower limit.

14. The system of claim 12, wherein the instructions are executable by the one or more processors to determine the failure mode of the target fueling system in response to the target field target performance being judged to satisfy one of the plurality of predetermined rules.

15. The system of claim 11, wherein the instructions are executable by the one or more processors to perform one or more preliminary fault checks separately from evaluating the target field target performance data using the failure mode model.

16. The system of claim 15, wherein the one or more preliminary fault checks comprises evaluating whether an injector circuit fault code condition is true and identifying an injector circuit condition in response to said evaluating.

17. The system of claim 15, wherein the one or more preliminary fault checks comprises evaluating whether a pressure exceeds a leakage threshold and whether a mechanical dumping valve pop-off count exceeds a threshold and identifying one of a mechanical dumping valve popped off condition, a mechanical dumping valve erosion condition, and an injector check ball crack condition in response to said evaluating.

18. The system of claim 11, wherein the instructions are executable by the one or more processors to evaluate the field target performance data using the failure mode model diagnosing a present state of the target engine system.

19. The system of claim 11, wherein the instructions are executable by the one or more processors to evaluate the field target performance data using the failure mode model to predict a future state of the target engine system.

20. The system of claim 11, wherein the compensatory action comprises one or more of: modifying operation of the target engine system, providing an operator perceptible notification to an operator of the target engine system, and scheduling service of the target engine system.
